(19) United States
(12) Patent Application Publication
(10) Pub. No.: US 2021/0071704 A1
(43) Pub. Date: Mar. 11, 2021

(54) Toilet Bolt Cap

(71) Applicant: PF Waterworks LP, Houston, TX (US)

(72) Inventors: Sanjay Ahuja, Katy, TX (US); Dingyan Yu, Ningbo (CN)

(73) Assignee: PF Waterworks LP, Houston, TX (US)

(21) Appl. No.: 17/017,991

(22) Filed: Sep. 11, 2020

Related U.S. Application Data
(60) Provisional application No. 62/899,125, filed on Sep. 11, 2019.
(60) Provisional application No. 62/911,290, filed on Oct. 6, 2019.

(51) Int. Cl. F16B 37/14; E03D 11/16

(52) U.S. Cl. CPC F16B 37/14; F16B 2200/50; E03D 11/16

(57) ABSTRACT

A cap for covering a bolt and its nut comprising a base and a cover. The base comprises a cylinder having a side wall and a circumferential groove or a flange on the side wall. Grabbers for a smaller-diameter bolt are on an inside surface of the side wall and extend inwardly and upwardly for engaging threads on the bolt as a pawl. Holders for a larger-diameter bolt are preferably also on the inside surface of the side wall and extend inwardly and upwardly and then bend into sections that extend along the length of the bolt and press against the bolt. The base is pushed onto and engaged with the bolt and covers the nut. The cover comprises an inverted cup having a mating circumferential flange or a groove for engaging the cover with the base. The cover hides the bolt.

### CROSS REFERENCE TO RELATED APPLICATIONS

This application claims priority to and the benefit of U.S. Provisional Patent Application Ser. Nos. 62/899,125 filed Sep. 11, 2019, and 62/911,290 filed Oct. 6, 2019, each of which is incorporated by reference.

### BACKGROUND OF THE INVENTION

### 1. Field of the Invention

This present invention pertains to bolts that anchor a toilet to a floor, and more particularly to a cap for covering such a bolt, as well as other bolts, where the bolt has a shank portion that extends beyond a nut.

### 2. Description of the Related Art

A toilet is typically anchored to a floor using two bolts, which have heads fitted in a flange under the toilet. The flange is attached to a drain pipe, and the toilet has a waste opening that is in a sealed engagement with the flange, which is generally attached to the floor. A threaded shank of the bolts projects upwardly from the flange and the floor. A toilet bowl has openings to receive the bolts. The toilet bowl is placed on the bolts, and a washer and a nut is placed on each bolt and used to fasten the toilet bowl to the flange, thereby anchoring the toilet bowl to the floor. The bolts are typically long and are often cut off above the nut after installation. A cap is generally used to cover the nut, washer and bolt for an improved appearance. However, the bolts are not always cut off because cutting the bolts off is time consuming. The bolts also have different sizes with one-fourth and five-sixteenths of an inch being common sizes used in the U.S. There is a need for a tall toilet bolt cap that can be used if the bolts are not cut to a short length and that can be used for different bolts that have different diameters.

### SUMMARY OF THE INVENTION

The present invention provides a toilet bolt cap that has a sufficient depth to cover an uncut bolt and can be used with at least a one-fourth (¼) inch bolt and a five-sixteenths ( 5/16) inch bolt and similar other or metric sizes. The cap can be used to cover and hide a nut and a bolt in which the shank of the bolt extends beyond the nut. One embodiment of the present invention comprises a toilet bolt cap that includes a base and a cover. The base comprises a cylinder or a cuboid having a side wall, a longitudinal axis and upper and lower ends, where the side wall defines an inside space and has inside and outside surfaces. A groove or a flange is provided in or on the outside surface of the side wall, preferably about the inner or outer circumference of the side wall. A plurality of grabbers are attached to the inside surface or formed integral with the side wall, and each grabber extends toward the upper end and toward the longitudinal axis of the base. Each grabber preferably has a triangular shape with an attached base portion and two free sides that intersect and form a point, which preferably engages the threads of a toilet bolt as a pawl with the threads functioning as a ratchet.

The cover comprises an inverted cup having a cylindrical or a cuboidal shape that corresponds to the shape and size of the base. The inverted cup has an outer wall, an enclosed top end and an open bottom end, and the outer wall has an inner surface. A flange or a groove is provided on or in the inner surface of the outer wall, or possibly on an outer surface of the outer wall. The flange or groove is preferably provided along the inner circumference of the inner surface of the outer wall. The base and the cover are designed and sized so that one of the base and the cover has the flange and the other has the groove. The cover matingly engages the base in a snap fit or an interference fit with the flange of one received in the groove of the other.

The base preferably further includes a plurality of holders that have an attached end and a free end. Each holder has a sloped portion and an upright portion. The sloped portion is attached to or formed integral with the inside surface of the side wall and slopes toward the longitudinal axis and away from the lower end of the side wall. The upright portion extends away from the lower end of the side wall, preferably nearly perpendicularly with respect to the lower end. The grabbers are preferably sized to secure the base to a smaller-diameter bolt, such as a one-quarter-inch-diameter bolt. The holders are preferably sized to secure the base to a larger-diameter bolt, such as a five-sixteenths-inch-diameter bolt.

In another embodiment, a toilet bolt cap has four posts or columns arranged to provide and define a bore, or preferably, two bores. Two opposing posts or columns define a bore for receiving the shank of a bolt having a one-quarter (¼) inch diameter, and another two opposing bores define a bore for receiving the shank of a bolt having a five-sixteenths ( 5/16) inch diameter. The posts or columns have female threads in one embodiment for a threaded engagement with a bolt. In another embodiment, no threads are included, and a cap is pushed onto a bolt and is held in place by a friction fit. The posts may have a plurality of ridges for a ratchet-type engagement with a bolt.

### BRIEF DESCRIPTION OF THE DRAWINGS

A better understanding of the invention can be obtained when the detailed description of exemplary embodiments set forth below is considered in conjunction with the attached drawings in which:

FIG. 1 is a side elevation of a toilet bowl TB and a toilet tank TT, which rests on and is fastened to a toilet bowl, and a toilet bolt cap TBC, according to the present invention.

FIG. 2 is a bottom plan view of a toilet bolt cap that has four arcuate posts, which have female threads, according to the present invention.

FIG. 3 is a cross-section of the toilet bolt cap of FIG. 2, as seen along the line A-A.

FIG. 4 is a cross-section of the toilet bolt cap of FIG. 2, as seen along the line B-B.

FIG. 5 is a perspective view of a toilet bolt cap as seen from a bottom view, which has four arcuate posts, which do not have female threads, according to the present invention.

FIG. 6A is a threaded tubular insert, according to the present invention.

FIG. 6B is a threaded tubular insert, according to the present invention.

FIG. 7 is a side elevation in cross-section of a toilet bolt cap, according to the present invention.

FIG. 8 is a side elevation in cross-section of the tubular insert of FIG. 6A received in the toilet bolt cap of FIG. 7.

FIG. 9 is a side elevation in cross-section of the tubular insert of FIG. 6B received in the toilet bolt cap of FIG. 7.

FIG. 10A is a threaded tubular insert, according to the present invention.

FIG. 10B is a threaded tubular insert, according to the present invention.

FIG. 11 is a side elevation in cross-section of a toilet bolt cap, according to the present invention.

FIG. 12 is a side elevation in cross-section of the tubular insert of FIG. 10A received in the toilet bolt cap of FIG. 11.

FIG. 13 is a side elevation in cross-section of the tubular insert of FIG. 10B received in the toilet bolt cap of FIG. 11.

FIG. 14 is a side elevation in cross-section of another embodiment of a toilet bolt cap, according to the present invention, which shows where the cap will be placed on a toilet bolt that fastens a toilet bowl to a toilet bowl flange.

FIG. 15 is a side elevation in cross-section of the toilet bolt cap of FIG. 14, after the toilet bowl has been fastened to the toilet bowl flange.

FIG. 16 is a side elevation in cross-section of the toilet bolt cap of FIG. 14, after the toilet bowl has been fastened to the toilet bowl flange with a toilet bolt that has a larger diameter than the bolt used in FIG. 15.

FIG. 17 is a side elevation in cross-section of the cover portion of the toilet bolt cap of FIG. 14.

FIG. 18 is a bottom plan view of the cover portion of FIG. 17.

FIG. 19 is a side elevation in cross-section of the base portion of the toilet bolt cap of FIG. 14.

FIG. 20 is a bottom plan view of the base portion of FIG. 19.

### DETAILED DESCRIPTION OF THE EXEMPLARY EMBODIMENTS

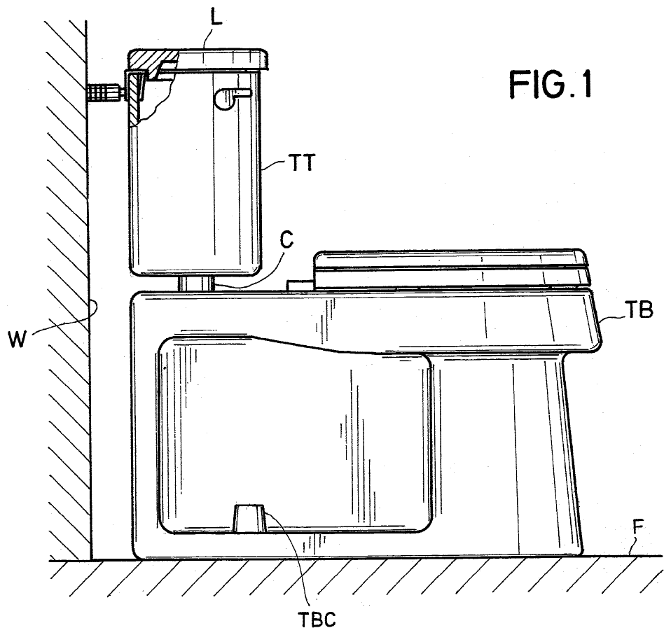

FIG. 1 is a side elevation of a toilet bowl TB and a toilet tank TT. The toilet tank rests on and is connected to the toilet bowl using a conventional connection C. A lid L covers an upper end of the toilet tank. The toilet tank is braced against a wall W. The toilet bowl is anchored to a drain flange, which is not shown and which is fastened to a floor F. A toilet bolt, which is not shown, is used to fasten the toilet bowl TB to the drain flange. The present invention is directed to a toilet bolt cap TBC, which is used to cover and hide the toilet bolt. FIG. 1 provides context for the present invention and is drawn from the applicant's U.S. Pat. No. 10,081,935.

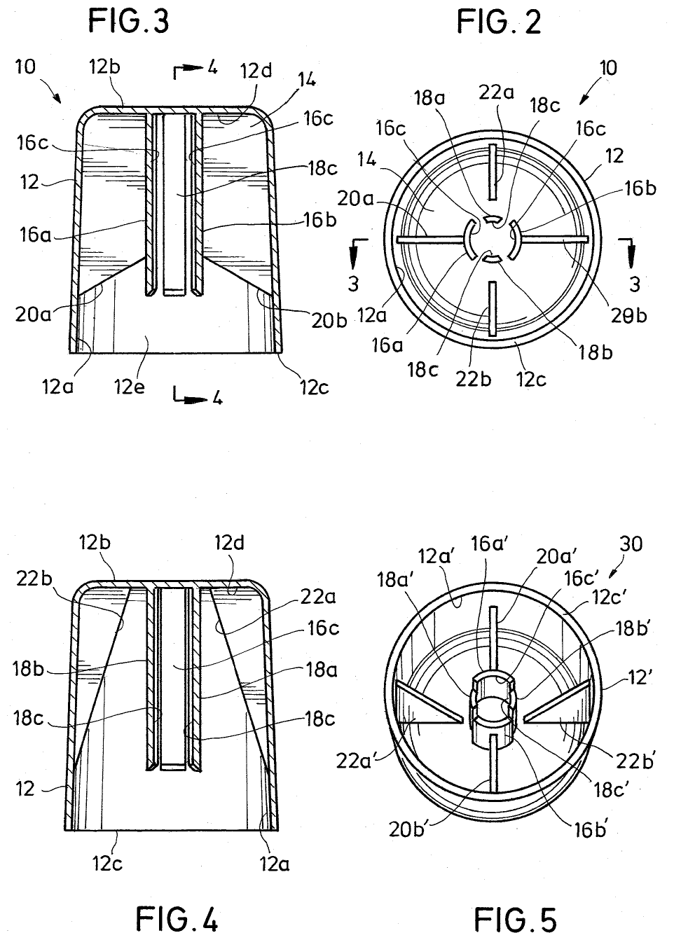

FIG. 2 is a bottom plan view of a toilet bolt cap 10 that has an outer shell 12 that defines an interior cavity 14. Outer shell 12 is cup-shaped and has an inside wall 12a, a closed end 12b and an opposing open end 12c, which can be seen in FIGS. 3 and 4. The closed end 12b has an inside surface 12d. Opposing arcuate-shaped posts 16a and 16b have female threads 16c that define an opening with a five-sixteenths inch diameter. Opposing arcuate-shaped posts 18a and 18b have female threads 18c that define an opening with a one-fourth inch diameter. The posts 16a, 16b, 18a and 18b are preferably formed integral with the outer shell 12 and extend from the inside surface 12d toward the open end 12c. The posts 16a, 16b, 18a and 18b do not extend all the way to the open end 12c and instead leave a space 12e that is sufficient to accommodate a nut, including a wing nut, and washer on a bolt. FIGS. 2 and 3 show a pair of braces 20a and 20b that extend between the inside wall 12a and the posts 16a and 16b, respectively, and support and strengthen the posts 16a and 16b. FIGS. 2 and 4 show a pair of angular braces 22a and 22b that extend from the inside surface 12d adjacent to the one-fourth inch posts 18a and 18b, respectively, to a point on the inside wall 12a opposite an open end of the posts 18a and 18b. The angular braces 22a and 22b provide some support at the base of the one-fourth inch posts 18a and 18b at the inside surface 12d, but the opposing open ends of the posts 18a and 18b can flex outwardly to accommodate a five-sixteenths inch bolt, which is received in the posts 16a and 16b.

FIG. 5 is a perspective view of a toilet bolt cap 30 as seen from a bottom view, which has four arcuate posts, which are sized and designed similar to the posts 16a, 16b, 18a and 18b in FIGS. 2-4, but which do not have female threads. The perspective view of FIG. 5 shows braces like 20a and 20b and angular braces like 22a and 22b in FIGS. 2-4. The toilet bolt cap 10 of FIGS. 2-4 is threaded onto a bolt. The toilet bolt cap 30 of FIG. 5 is pressed onto a bolt and held there by a friction fit or an interference fit.

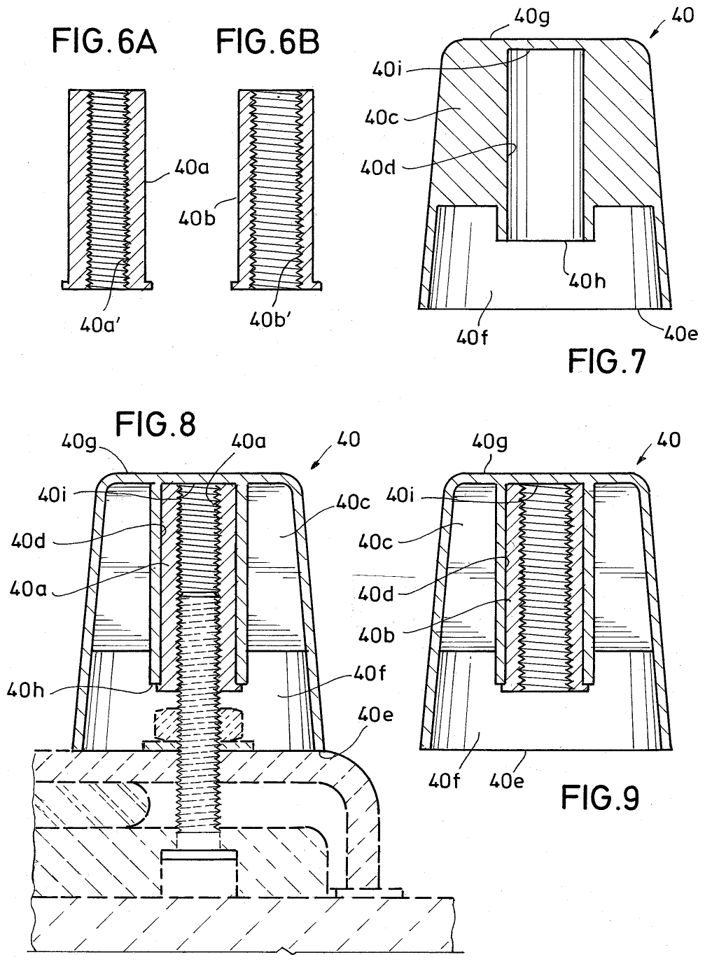

FIGS. 6A and 6B are tubular inserts 40a and 40b, respectively, which have a threaded bore with a one-fourth inch diameter for insert 40a and a five-sixteenths inch bore for insert 40b. FIG. 7 is a side elevation in cross-section of a toilet bolt cap 40, which has a solid inner core or a plurality of braces 40c that defines a tubular-shaped bore hole 40d. Toilet bolt cap 40 has an open lower end 40e, a cavity 40f for accommodating a nut on a toilet tank bolt and a top end 40g. The bore hole 40d has an open end 40h and a closed end 40i. To cover a one-fourth inch bolt and its washer and nut, one threads the tubular insert 40a onto the threaded shank of the bolt that extends beyond the nut. One then aligns the bore hole 40d above the tubular insert 40a and presses the cap 40 down on the bolt, thereby receiving the tubular insert 40a inside the bore hole 40 in a friction fit as shown in FIG. 8. To cover a five-sixteenths inch bolt and its washer and nut, one threads the tubular insert 40b onto the threaded shank of the bolt that extends beyond the nut. One then aligns the bore hole 40d above the tubular insert 40d and presses the cap 40 down on the bolt, thereby receiving the tubular insert 40b inside the bore hole 40 in a friction fit as shown in FIG. 9.

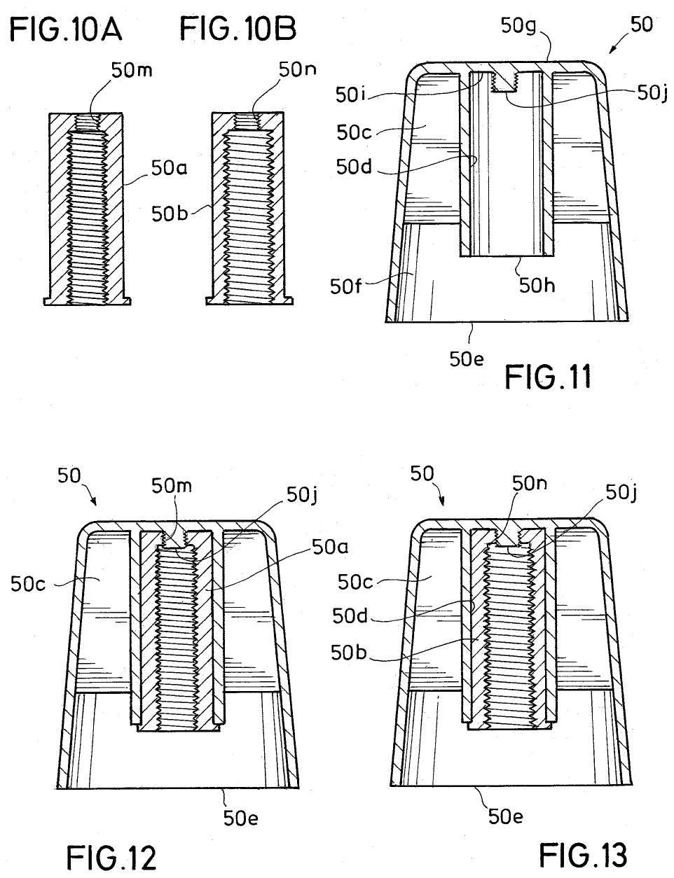

FIGS. 10A and 10B are tubular inserts 50a and 50b, respectively, which have a threaded bore with a one-fourth inch diameter for insert 50a and a five-sixteenths inch bore for insert 50b. FIG. 11 is a side elevation in cross-section of a toilet bolt cap 50, which has a solid inner core or a plurality of braces 50c that defines a tubular-shaped bore hole 50d. The bore hole 50d has a closed bottom end 50e. Toilet bolt cap 50 has an open lower end 50e, a cavity 50f for accommodating a nut on a toilet tank bolt and a top end 50g. The bore hole 50d has an open end 50h and a closed end 50i.

A threaded stud 50j is attached to or formed integral with the closed end 50i. The tubular inserts 50a and 50b have holes 50m and 50n, respectively, that are defined by threads and that are sized to receive the threaded stud 50j in a threaded engagement. To cover a one-fourth inch bolt and its washer and nut, one threads the tubular insert 50a onto the threaded shank of the bolt that extends beyond the nut. One then aligns the bore hole 50d above the tubular insert 50a and presses the cap 50 down on the bolt and screws the stud 50j into the hole 50m, thereby receiving the tubular insert 50a inside the bore hole 50d in a threaded engagement as shown in FIG. 12. To cover a five-sixteenths inch bolt and its washer and nut, one threads the tubular insert 50b onto the threaded shank of the bolt that extends beyond the nut. One then aligns the bore hole 50d above the tubular insert 50b and presses the cap 50 down on the bolt and threads the stud 50j into the hole 50n, thereby receiving the tubular insert 50b inside the bore hole 50d in a threaded engagement as shown in FIG. 13.

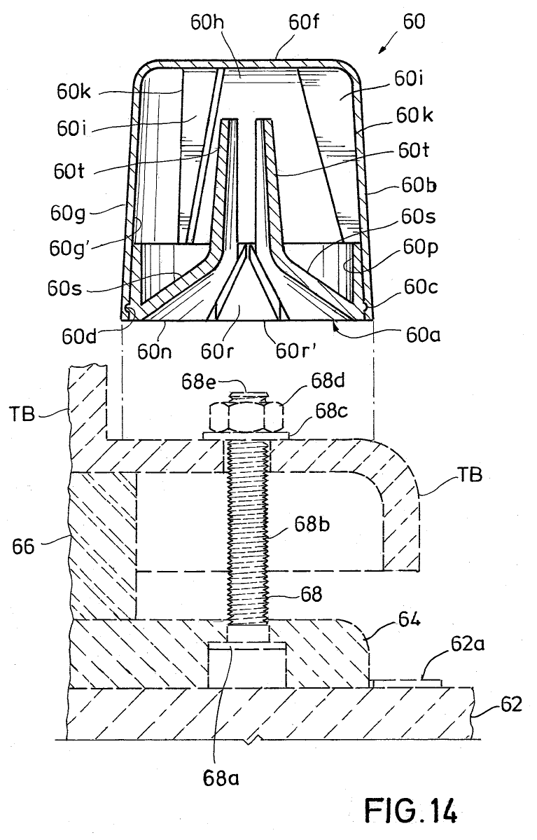

Turning now to another embodiment of the present invention, a side elevation in cross section of a toilet bolt cap 60 is shown in FIG. 14. Toilet bolt cap 60 comprises a base 60a and a cover 60b. Base 60a attaches to a toilet bolt, and cover 60b is pressed onto the base 60a and held to or engaged with the base 60a by a ridge or flange 60c around the circumference or perimeter of the base 60a, which is received in a groove 60d in an inner circumference of the cover 60b in a snap fit. FIG. 14 shows in partial cross-section a floor 62. With reference to U.S. Pat. No. 6,691,331, issued to Gallacher et al., a toilet bowl flange 64 is fastened to a drain pipe (not shown) and to the floor 62. A gasket 66 provides a seal between toilet bowl TB and flange 64 for a sealed flow path for water and waste from the toilet bowl TB and the flange 64, which is connected to and sealed with the drain pipe, which is not shown. A toilet bolt 68 has a head 68a that is trapped in the flange 64 and a shank 68b that passes through a hole in a bottom flange of the toilet bowl TB. A washer 68c and a nut 68d are engaged with the shank 68b, and the nut 68d is tightened, which compresses gasket 66 and lowers the toilet bowl TB onto an optional seal 62a on floor 62. An upper end 68e of the bolt 68 protrudes upwardly from the nut 68d after the nut 68d is tightened and screwed downwardly on the shank 68b.

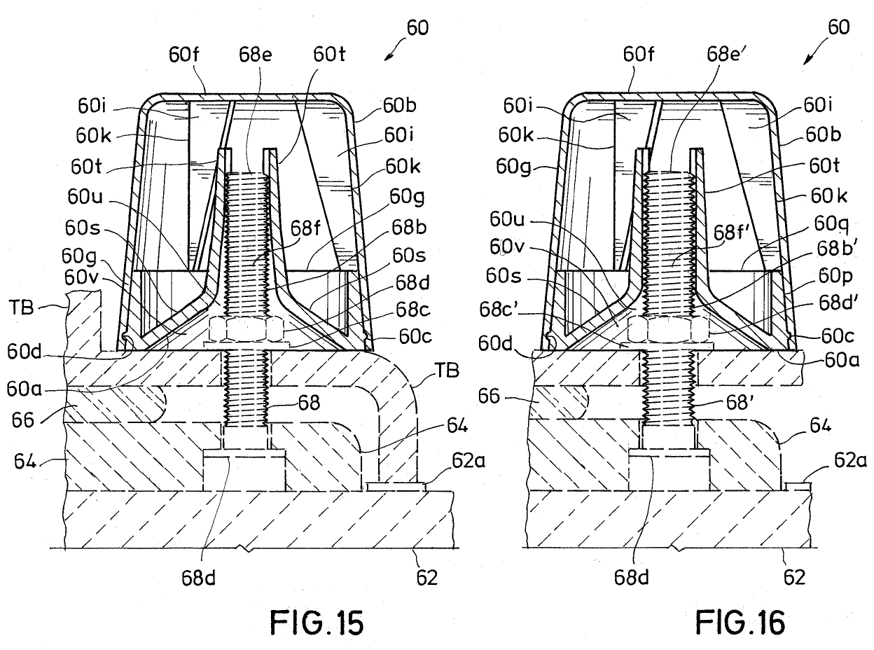

FIG. 15 shows the toilet bowl TB resting on the seal 62a on the floor 62 after the nut 68d is tightened. A significant portion of the shank 68b of the bolt 68 protrudes upwardly above the nut 68c. if the bolt shank 68b is cut off at the upper edge of the nut 68d, then a traditional toilet bolt cap can be used. If the bolt shank 68b is not cut off at the upper edge of the nut 68d and instead protrudes sufficiently above the nut 68d, then cap 60 can be used to cover and hide the bolt 68. FIG. 3 illustrates the bolt shank 68b having a one-quarter inch diameter. FIG. 16 illustrates a bolt shank 68b′ of a bolt 68′ having a five-sixteenths inch diameter. Otherwise, FIGS. 15 and 16 are the same.

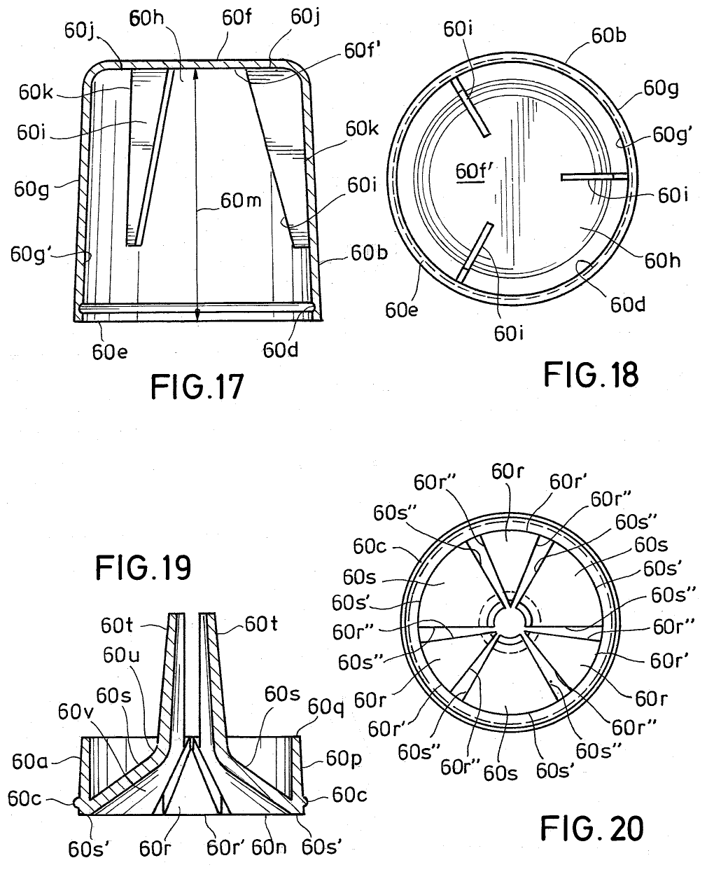

FIG. 17 is a side elevation in partial cross-section of cover 60b of toilet bolt cap 60. Cover 60b has a lower end 60e, which is open, and an upper end 60f, which is closed. FIG. 18 is a bottom plan view of cover 60b as seen through its open end 60e. Cover 60b has the shape of an inverted cup. Cover 60b has a side wall 60g, which is either cylindrical or slightly conical with the open lower end 60e having a slightly larger diameter than the closed upper end 60f. Closed upper end 60f and side wall 60g have inside surfaces 60f′ and 60g′, respectively, which define a space or internal volume 60h. Cover 60b preferably has three stiffening ribs 60i. The stiffening ribs 60i are generally triangular in shape and resemble a right triangle, except without a 90-degree angle if the side wall 60g is somewhat conical in shape. Ribs 60i have a relatively short base portion 60j, which is attached to or made integral with the inside surface 60f′ of the closed end 60f. Ribs 60i have a relatively long side portion 60k, which is attached to or made integral with the inside surface 60g′ of the side wall 60g. Cover 60b has an inside, longitudinal length 60m, and the ribs 60i have a longitudinal length of approximately and preferably two-thirds of length 60m.

FIG. 19 is a side elevation in partial cross-section of base 60a of toilet bolt cap 60. Base 60a is pressed onto toilet bolt 68 or 68′ and secured to bolt 68 or 68′ by an interference or friction fit. Base 60a has a lower end 60n, and the ridge or flange 60c is proximate to and just above the lower end 60n. A cylindrical side wall 60p extends longitudinally and upwardly from the lower end 60n. The cylindrical side wall 60p has a circumference, an upper end 60q and a longitudinal length of approximately and preferably one-third of the length 60m. The ridge or flange 60c preferably extends around the full circumference of the side wall 60p.

FIG. 20 is a bottom plan view of base 60a as seen by looking up at the lower end 60n. Base 60a has preferably three triangular grabbers 60r that have a base portion 60r′ that is attached to or formed integral with the lower end 60n of the base 60a, as shown in FIGS. 19 and 20. Each of the three triangular grabbers 60r have two free sides 60r″ that terminate and form a point at an end distal to the base portion 60r′. The free sides 60r″ slope inwardly and upwardly from the base portion 60r′ toward an axial center point, which is toward where the toilet bolt will be received. The three triangular grabbers 60r are designed and sized such that their pointed ends opposite of the base portion 60r′ circumscribe a circle in which a one-quarter inch diameter toilet bolt is engaged and trapped. The grabbers 60r also grab and hold a five-sixteenths-inch diameter toilet bolt. At least two grabbers are preferred, and more than three can be used. The grabbers 60r serve as a pawl, and the threads on the toilet bolt serve as a ratchet; and combined, they form a pawl-and-ratchet mechanism for holding the base 60a onto the toilet bolt 68 or 68′. The grabbers 60r can be referred to as pawls. With a sufficient amount of the shank 68b extending beyond the nut 68d, the shank extension 68b will be caught and held in engagement with the base 60a, thereby fastening the base 60a to the toilet bolt 68 or the toilet bolt 68′. The lower end 60n of the base 60a contacts a top surface of the toilet bowl TB around the toilet bolt 68.

Base 60a preferably also has preferably three holders 60s interspersed between the grabbers 60r. Each of the three holders 60s have a base portion 60s′ that is attached to or formed integral with the lower end 60n of the base 60a. Each of the three holders 60s have two free sides 60s″ that extend upwardly and inwardly toward an axial center point, as do the grabbers 60r. However, each of the holders 60s terminate in an arcuate riser 60t that extends longitudinally away from the base portion 60s′. The two free sides 60s″ first extend upwardly and inwardly toward the axial center point and then transition with a bend 60u that turns upwardly and becomes the arcuate riser 60t. The arcuate risers 60t are nearly perpendicular with respect to the lower end 60n or are at an angle between about 80 and about 90 degrees with respect to the lower end 60n. The free sides 60s″ may form an angle of about 30 degrees with respect to the lower end 60n. The angle of the bend 60u between the arcuate risers 60t and the free sides 60s″ would be about 150 degrees. The base portion 60s′ and the two free sides 60s″ define a sloped, triangular portion of each holder 60s. The arcuate riser 60t can be referred to as an upright portion of the holder 60s. The bend 60u can be referred to as a bend portion of the holder 60s.

Two or more of the arcuate risers 60t circumscribe a circle around an axial center point and around a longitudinal axis of the toilet bolt cap 60. An inner surface of the arcuate risers 60t may be smooth, grooved or threaded, and in any case, the arcuate risers press against and hold a toilet bolt. The holders 60s and their arcuate risers 60t are designed and sized to press against and hold onto a five-sixteenths-inch-diameter toilet bolt 68′. The three triangular grabbers 60r are designed and sized press against and hold onto a one-quarter-inch-diameter toilet bolt 68 in the nature of a pawl-and-ratchet mechanism The inner surface of the arcuate risers 60t may be grooved so as to also operate in the nature of a pawl-and-ratchet mechanism or threaded so that the base 60a can be threaded onto a bolt 68 or 68′. The inner surface of the arcuate risers 60t may also be smooth, and the bolt 68 or 68′ can cut into the inner surface for a self-threading attachment. The simplest way to make the base would be with a smooth inner surface for the risers 60t and to merely push the base 60a onto a bolt 68 or 68′ for a press-fit engagement. The grabbers 60r and the holders 60s and their arcuate risers 60t have been described as being sized and designed for a particular size for the diameter of a bolt, but the grabbers 60r and the holders 60s and their arcuate risers 60t can actually hold bolts having different diameters than described here, with each being useful for one-quarter or five-sixteenths-inch diameters, as well as for other sizes and for metric sizes.

Returning to FIGS. 15 and 16, the toilet bowl TB has been tightened down onto the floor seal 62a, and a toilet bolt shank extension 68f or 68f′ extends above the nut 68d because the toilet bolt 68 was nut cut off or was not cut off adjacent to and just above the nut 68d. The base 60a of the toilet bolt cap 60 has been pressed down on the shank extension 68f or 68f′, thereby engaging the base 60a with the bolt 68 or 68′. The cover 60b of the toilet bolt cap 60 has been pressed down on the base 60a, thereby receiving the ridge or flange 60c in the groove 60d, which holds the cover 60b onto the base 60a. Because the grabbers 60r and the holders 60s slope upwardly toward the upper end 60f of the cover 60b, a space 60v is provided for receiving the nut 68d or 68d′ and the washer 68c or 68c′.

One cannot see a grabber 68r in FIGS. 15 and 16 because in these cross-sections, the grabber 60r is behind the bolts 68 and 68′. However, the grabbers 60r hold each of the bolts 68 and 68′ using a pawl-and-ratchet mechanism. The holder 60s and their arcuate risers 60t are visible in FIGS. 15 and 16 and are shown engaged with the bolts 68 and 68′ in a friction or interference fit, as the arcuate risers 60t press against the bolt 68 or 68′. The stiffening ribs 60i in the cover 60b abut the upper end 60q of the side wall 60p of the base 60a.

The embodiment of FIGS. 14-20 can be described briefly as a cap for covering a bolt and its nut, which comprises a base and a cover. The base comprises a cylinder having a side wall and a circumferential groove or a flange on the side wall. Grabbers for a smaller-diameter bolt are on an inside surface of the side wall and extend inwardly and upwardly for engaging threads on the bolt as a pawl. Holders for a larger-diameter bolt are preferably also on the inside surface of the side wall and extend inwardly and upwardly and then bend into sections that extend along the length of the bolt and press against the bolt. The base is pushed onto and engaged with the bolt, and the base covers the nut. The cover comprises an inverted cup having a mating circumferential flange or a groove for engaging the cover with the base. The cover hides the bolt.

The connection of the cover 60b to the base 60a has been described as a circumferential flange received in a mating circumferential groove. However, a variety of other fastening means can be used for fastening the cover to the base. U.S. Pat. No. 10,495,132, issued to Rawdon et al. on Dec. 3, 2019, is incorporated by reference for its disclosure of a number of different fastening means that can be used to fasten the cover 60b to the base 60a. A number of different ways to design and use a pawl-and-ratchet mechanism are disclosed, where a ratchet can be thought of as a shoulder, a thread or a tooth, and a pawl can be thought of as a lever with a fixed end and a free end pressed in one direction by a spring force to engage the ratchet, where movement of the ratchet is free in one direction but resisted by the pawl in the opposite direction. Cover 60b can be fastened to base 60a using a pawl-and-ratchet mechanism. For example, the cover 60b and the base 60 can have opposing shoulders, such as a flange with one edge rounded and another edge at a right angle, where the rounded edges facilitate pressing the cover onto the base, while the square sides become engaged for resisting removal of the cover from the base. Another fastening means is the cover could be threaded onto the base with the addition of threads. The cover could also be glued or bonded to the base during or before installation. The base 60a in FIG. 19 and the cover 60b in FIG. 17 could be a single, integral toilet bolt cap for installation, since the toilet bolt cap is simply pressed onto the upper portion 68 or 68f′ of the toilet bolt 68 or 68′, respectively. The base 60a in FIG. 19 and the cover 60b in FIG. 17 are made as separate parts for ease of manufacturing molded plastic parts. Otherwise, the internal components would be difficult to make, but a technology such as 3-D printing may make it possible to make the base 60a and the cover 60b as one integral article of manufacture. In any case, the cover 60b could be glued, bonded or otherwise attached to the base 60a during the manufacturing process.

### Embodiments of the Invention

1. A toilet bolt cover for covering a toilet bolt and a nut, where the toilet bolt extends some distance away from the toilet and beyond the nut, the toilet bolt cover comprising:
a cup-shaped cap having an open end, an opposing closed end and a sidewall between the open and closed ends, wherein the sidewall and the closed end define an interior cavity;
a first pair of opposing posts received in the cavity and attached to or formed integral with the closed end, wherein the first pair of opposing posts are spaced apart a first distance;
a second pair of opposing posts received in the cavity and attached to or formed integral with the closed end, wherein the second pair of opposing posts are spaced apart a second distance, and wherein the second distance is different from the first distance, wherein
the first and second pairs of opposing posts extend from the closed end toward the open end, and wherein
the first and second pairs of opposing posts are arranged so as to partially define a bore hole for receiving the toilet bolt.

2. The toilet bolt cover of embodiment 1, wherein the first distance is about one-fourth of an inch.

3. The toilet bolt cover of embodiment 1 or 2, wherein the second distance is about five-sixteenths of an inch.

4. The toilet bolt cover of embodiment 1, wherein the first and second pairs of opposing posts have an arcuate shape for circumscribing a circular shape.

5. The toilet bolt cover of embodiment 1 or 4, wherein the first and second pairs of opposing posts have female threads for receiving male threads on the toilet bolt.

6. The toilet bolt cover of embodiment 4, wherein the first and second pairs of opposing posts do not have female threads for receiving male threads on the toilet bolt, and wherein the first distance is about one-fourth of an inch and the second distance is about five-sixteenths of an inch.

7. The toilet bolt cover of embodiment 5, wherein the first distance is about one-fourth of an inch and the second distance is about five-sixteenths of an inch.

8. The toilet bolt cover of embodiment 1, further comprising a brace extending between an inside surface of the sidewall of the cap and each of the posts in the first pair of opposing posts.

9. The toilet bolt cover of embodiment 1 or 8, further comprising a first angular brace having a triangular shape and extending between an inside surface of the closed end adjacent to one of the posts in the second pair of opposing posts toward a point on the inside surface of the sidewall of the cap.

10. The toilet bolt cover of embodiment 9, further comprising a second angular brace having a triangular shape and extending between an inside surface of the closed end adjacent to the other post of the posts in the second pair of opposing posts toward a point on the inside surface of the sidewall of the cap.

11. The toilet bolt cover of embodiment 10, wherein there is space in the interior cavity for accommodating the nut on the toilet bolt.

12. The toilet bolt cover of embodiment 1, wherein the first pair of opposing posts have an arcuate shape for circumscribing a toilet bolt have a five-sixteenths inch diameter, and wherein the second pair of opposing posts have an arcuate shape for circumscribing a toilet bolt have a one-fourth inch diameter.

13. The toilet bolt cover of embodiment 12, wherein the first and second pairs of opposing posts have female threads for threadedly engaging the toilet bolt.

14. A toilet bolt cover for covering a toilet bolt and a nut, where the toilet bolt extends some distance away from the toilet and beyond the nut, the toilet bolt cover comprising:
a cap having a bore hole that provides an opening on one end of the cap, wherein the bore hole does not extend all the way through the cap; and
a removable insert received in the bore hole, wherein the insert has a tubular shape with a longitudinal opening defined by female threads sized and designed to receive the toilet bolt, wherein the insert can be threaded onto the toilet bolt after which the insert and the toilet bolt can be received in the cap so that the cap will cover and hide the toilet bolt.

15. The toilet bolt cover of embodiment 14, further comprising a second insert that has a tubular shape with a longitudinal opening defined by female threads sized and designed to receive a toilet bolt having a different diameter that the toilet bolt received in the removable insert.

16. The toilet bolt cover of embodiment 15, wherein the cap can be detached from the second insert after assembly.

17. The toilet bolt cover of embodiment 14, wherein the bore hole in the cap has an upper end defined by an inner surface, further comprising a stud having male threads extending from the inner surface in the bore hole, wherein the removable insert has an upper end and a threaded opening, wherein the stud is in threaded engagement with the threaded opening in the removable insert.

18. A kit, comprising the toilet bolt cover of embodiment 17 and a second insert that has a tubular shape with a longitudinal opening defined by female threads sized and designed to receive a toilet bolt having a different diameter that the toilet bolt received in the removable insert.

19. The kit of embodiment 18, wherein second insert also has an upper end and a threaded opening for receiving the stud, wherein either the removable insert of the second insert is received in the cap.

20. A toilet bolt cap for covering a toilet bolt, which fastens a toilet bowl to a toilet bowl flange, comprising: a base and a cover that attaches to the base, wherein
the base has a side wall, a lower end of the side wall and an upper end of the side wall, wherein
   the side wall of the base has an outside surface, wherein
   the outside surface of the side wall of the base has a circumferential flange or groove, wherein
   the base has a plurality of grabbers that are attached to or formed integral with the lower end of the base, wherein
   each grabber extends away from the lower end of the base and slopes inwardly toward a longitudinal axis of the base, wherein
   the grabbers are sized and designed to press against the toilet bolt, wherein
the cover has a side wall, a lower end that is open and an upper end that is closed, wherein
   the side wall of the cover has an inside surface, and wherein
      the inside surface of the side wall of the cover has a circumferential groove or flange for matingly engaging the circumferential flange or groove on or in the outside surface of the side wall of the base in a snap fit and/or in an interference fit.

21. The toilet bolt cap of embodiment 20, wherein
the base has a plurality of holders, wherein
each holder extends away from the lower end of the base and slopes inwardly toward a longitudinal axis of the base and then transition through a bend and then extends away from the lower end of the base and becomes a riser, wherein
the risers are sized and designed to press against the toilet bolt.

22. The toilet bolt cap of embodiment 20 or 21, wherein the cover has a plurality of stiffening ribs attached to or formed integral with an inside surface of the upper end and the side wall of the cover.

23. The toilet bolt cap of embodiment 21, wherein the side wall of the base has an inside surface, wherein the grabbers and the holders of the base have a lower surface, and wherein the inside surface of the side wall of the base and the lower surfaces of the grabbers and holders define a space for covering a nut on a toilet bolt.

24. The toilet bolt cap of embodiment 21, wherein a cross-section of each riser has an arcuate shape for matingly engaging a toilet bolt.

25. A method for covering and hiding a toilet bolt that is used to fasten a toilet bowl to a toilet bowl flange, thereby indirectly fastening the toilet bowl to a floor, the method comprising the steps of:
cutting a hole in a floor;
providing a vertical section of drain pipe in the hole and below the floor;
connecting a toilet bowl flange to the drain pipe;
fastening the toilet bowl flange to the floor, wherein the toilet bowl flange has two or more holes and adjacent slots for receiving and holing the head of a bolt;
placing two toilet bowl bolts in the holes and sliding the bolts into the slots, wherein the toilet bowl flange retains and secures a head of each toilet bowl bolt;
placing a wax seal or a gasket on a drain flange of a toilet bowl;
placing the toilet bowl on the toilet bowl flange such that the toilet bowl bolts protrude through holes in a base portion of the toilet bowl;
placing a washer and then a nut on each toilet bowl bolt;
tightening the nuts to fasten the toilet bowl to the toilet bowl flange, wherein a portion of the shank of each bolt extends above the nut (referred to as a shank extension) at least one-eighth of an inch, preferably at least a quarter of an inch and typically one inch or more, wherein the toilet bowl bolts are not cut off after the installation;
pushing the base portion of the toilet bolt cap of embodiment 20 down onto one of the shank extensions, wherein the base portion covers the nut and washer, wherein the grabbers engage threads on the shank extension, wherein the grabbers function as a pawl, and
wherein the threads function as a ratchet, thereby holding the base portion down and in contact with the base portion of the toilet bowl;
pushing the cover portion of the toilet bolt cap of embodiment 20 down onto the base portion of the toilet bolt cap; and
engaging the flange or groove of the cover with the opposite and mating groove or flange of the base portion in a snap fit or interference fit; thereby fastening the cover portion to the base portion and forming the toilet bolt cap.

26. The method of embodiment 25, wherein the base portion of the toilet bolt cap further includes a plurality of holders, wherein each holder extends away from the lower end of the base and slopes inwardly toward a longitudinal axis of the base and then transition through a bend and then extends away from the lower end of the base and becomes a riser, and wherein the risers are sized and designed to press against the shank of the toilet bolt that extends over the nut.

27. A toilet bolt cap for covering a toilet bolt, which fastens a toilet bowl to a toilet bowl flange, comprising: a base and a cover that attaches to the base, wherein
the base has a side wall, a lower end of the side wall and an upper end of the side wall, wherein
   the side wall of the base has an outside surface, wherein
   the outside surface of the side wall of the base has a circumferential flange or groove, wherein
   the base has a plurality of grabbers that are attached to or formed integral with the lower end of the base, wherein
   each grabber extends away from the lower end of the base and slopes inwardly toward a longitudinal axis of the base, wherein
   the grabbers are sized and designed to press against the toilet bolt, wherein the base has a plurality of holders, wherein
   each holder extends away from the lower end of the base and slopes inwardly toward a longitudinal axis of the base and then transition through a bend and then extends away from the lower end of the base and becomes a riser, wherein
   the risers are sized and designed to press against the toilet bolt, wherein
the cover has a side wall, a lower end that is open and an upper end that is closed, wherein
   the side wall of the cover has an inside surface, and wherein
   the inside surface of the side wall of the cover has a circumferential groove or flange for matingly engaging the circumferential flange or groove on or in the outside surface of the side wall of the base in a snap fit and/or in an interference fit.

28. The toilet bolt cap of embodiment 27, wherein the cover has a plurality of stiffening ribs attached to or formed integral with an inside surface of the upper end and the side wall of the cover.

29. The toilet bolt cap of embodiment 27, wherein the side wall of the base has an inside surface, wherein the grabbers and the holders of the base have a lower surface, and wherein the inside surface of the side wall of the base and the lower surfaces of the grabbers and holders define a space for covering a nut on a toilet bolt.

30. The toilet bolt cap of embodiment 27, wherein a cross-section of each riser has an arcuate shape for matingly engaging a toilet bolt.

The toilet bolt cap covers the toilet bolt shank extension, the nut and the washer. The nut and washer are below the base portion of the toilet bolt cap. The shank of the bolt above the nut is engaged by the grabbers for fastening the base to the bolt. The cover portion of the toilet bolt cap covers and hides the portion of the bolt above the nut, the nut itself, the washer and the base portion of the toilet bolt cap. In one embodiment, the toilet bolt cap further includes the holders described in embodiment 21 above.

The toilet bolt cap of the present invention can be used in other applications for covering and hiding bolt shank extensions that extend or protrude beyond a nut on the shank of a bolt. The toilet bolt cap of the present invention can be made of metal or plastic or any material that can provide the functionality described herein. A thermoplastic, such as polypropylene, polystyrene or acrylonitrile butadiene styrene (ABS), may be suitable, as well as a thermosetting plastic such as a polyester or a polyurethane. A preferred shape for the toilet bolt cap is a hollow cylinder, including a somewhat conical shape, but a hollow cuboid is also a suitable shape. A hollow cuboid shape refers to a shape that has four solid or closed sides that are square or rectangular in shape and two opposing open or closed ends that are square or rectangular in shape. The sides preferably adjoin at a right angle in the hollow cuboid shape.

31. The toilet bolt cap of embodiment 20 or 21, wherein the base and the cover have a cuboid shape, and wherein the toilet bolt cap that has four sides and a closed upper end.

32. A method for covering a bolt that extends beyond a nut, the method comprising the steps of:
pushing a base onto the bolt, wherein the base has a side wall, wherein the base has a cavity for receiving the nut, wherein the base has a plurality of grabbers or holders that press against the bolt for holding the base onto the bolt, and wherein base has a first engagement means; and
pushing a cover onto the base, wherein the cover hides the bolt and the base, wherein the cover has a second engagement means that engages the first engagement means in a snap fit or in an interference fit, wherein one of the first and second engagement means comprises a circumferential groove and the other of the first and second engagement means comprises a circumferential flange that is received in the circumferential groove.

32. The method of embodiment 31, wherein the grabbers or holders have an attached end that is attached to or formed integral with an inside surface of the side wall, and wherein the grabbers or holders have a sloped portion that slopes away from a lower end of the base and toward a longitudinal axis of the base.

33. A toilet bolt cap comprising: a base and a cover,
wherein the base comprises:
a cylinder or a cuboid having a side wall, a longitudinal axis and upper and lower ends, wherein the side wall defines an inside space and has inside and outside surfaces;
a first fastening means on the side wall; and
a plurality of pawls in the inside space that are attached to the inside surface or formed integral with the side wall, wherein each pawl slopes upwardly toward the upper end and extends toward the longitudinal axis, wherein each pawl is designed and sized for engaging teeth on a bolt,
wherein the cover comprises:
an inverted cup having a cylindrical or a cuboidal shape that corresponds to the shape and size of the base, wherein the inverted cup has an outer wall, an enclosed top end and an open bottom end, and wherein the outer wall has an inner surface; and
a second fastening means on the outer wall, wherein
the base and the cover are designed and sized so that the second fastening means engages the first fastening means for attaching the cover to the base.

34. The toilet bolt cap of embodiment 33, wherein the fastening means include a flange-and-groove combination, a pawl-and-ratchet mechanism and a threaded engagement.

Having described the invention above, various modifications of the techniques, procedures, materials, and equipment will be apparent to those skilled in the art. It is intended that all such variations within the scope and spirit of the invention be included within the scope of the appended claims.

What is claimed is:

1. A toilet bolt cap comprising: a base and a cover,
wherein the base comprises:
a cylinder or a cuboid having a side wall, a longitudinal axis and upper and lower ends, wherein the side wall defines an inside space and has inside and outside surfaces;
a first fastening means on the side wall; and
a plurality of pawls in the inside space that are attached to the inside surface or formed integral with the side wall, wherein each pawl slopes upwardly toward the upper end and extends toward the longitudinal axis, wherein each pawl is designed and sized for engaging teeth on an end-portion of a bolt for attaching the base to the end-portion of the bolt,
wherein the cover comprises:
an inverted cup having a cylindrical or a cuboidal shape that corresponds to the shape and size of the base, wherein the inverted cup has an outer wall, an enclosed top end and an open bottom end, and wherein the outer wall has an inner surface; and
a second fastening means on the outer wall, wherein
the base and the cover are designed and sized so that the second fastening means engages the first fastening means for attaching the cover to the base and for hiding the end-portion of the bolt inside the cover.

2. The toilet bolt cap of claim 1, wherein the first and second fastening means comprise at least one of a flange, a groove, a pawl, a ratchet or threads.

3. A toilet bolt cap comprising: a base and a cover,
wherein the base comprises:
a cylinder or a cuboid having a side wall, a longitudinal axis and upper and lower ends, wherein the side wall defines an inside space and has inside and outside surfaces;
a groove or a flange in or on the outside surface of the side wall; and
a plurality of grabbers in the inside space that are attached to the inside surface or formed integral with the side wall, wherein each grabber slopes upwardly toward the upper end and extends toward the longitudinal axis, wherein each grabber serves the function of a pawl for engaging teeth on a bolt,
wherein the cover comprises:
an inverted cup having a cylindrical or a cuboidal shape that corresponds to the shape and size of the base, wherein the inverted cup has an outer wall, an enclosed top end and an open bottom end, and wherein the outer wall has an inner surface; and
a flange or a groove on or in the inner surface of the outer wall, wherein
the base and the cover are designed and sized so that one of the base and the cover has the flange and the other has the groove, and wherein the cover matingly engages the base in a snap fit or an interference fit with the flange of one received in the groove of the other.

4. The toilet bolt cap of claim 3, wherein the grabbers have a triangular shape with two free edges and one attached edge, wherein the two free edges intersect and form a point, and wherein the base and the cover are designed and sized so that the point engages threads on a bolt received in the base between the grabbers.

5. The toilet bolt cap of claim 3, wherein the base further comprises a plurality of holders that have an attached end that is attached to or formed integral with the inside surface of the side wall and a free end, wherein each holder has a sloped portion and an upright portion, wherein the sloped portion is attached to or formed integral with the inside surface of the side wall and slopes toward the longitudinal axis and away from the lower end of the side wall, and wherein the upright portion extends away from the lower end of the side wall.

6. The toilet bolt cap of claim 5, wherein each holder has a bend portion between the sloped portion and the upright portion.

7. The toilet bolt cap of claim 5, wherein the base is designed and sized so that the upright portion of each holder contacts and engages a bolt received in the base, and wherein one or both of the grabbers and the holders contact and engage a bolt received in the base.

8. The toilet bolt cap of claim 3, wherein a volume is defined by the inside surface of the base and a lower surface of the grabbers that is above the lower end of the side wall, and wherein the base and the cover are designed and sized so that the volume is adequate to accommodate a nut and a washer on a toilet bolt.

9. The toilet bolt cap of claim 3, wherein the cover further comprises a plurality of stiffening ribs received inside the inverted cup and attached to or formed integral with the outer wall and the enclosed top of the inverted cup.

10. A toilet bolt cap comprising: a base and a cover,
wherein the base comprises:
a cylinder or a cuboid having a side wall, a longitudinal axis and upper and lower ends, wherein the side wall defines an inside space and has inside and outside surfaces;
a groove or a flange in or on the outside surface of the side wall; and
a plurality of holders that have an attached end that is attached to or formed integral with the inside surface of the side wall and a free end, wherein each holder has a sloped portion and an upright portion, wherein the sloped portion is attached to or formed integral with the inside surface of the side wall and slopes toward the longitudinal axis and away from the lower end of the side wall, and wherein the upright portion extends away from the lower end of the side wall,
wherein the cover comprises:
an inverted cup having a cylindrical or a cuboidal shape that corresponds to the shape and size of the base, wherein the inverted cup has an outer wall, an enclosed top end and an open bottom end, and wherein the outer wall has an inner surface; and
a flange or a groove on or in the inner surface of the outer wall, wherein
the base and the cover are designed and sized so that one of the base and the cover has the flange and the other has the groove, and wherein the cover matingly engages the base in a snap fit or an interference fit with the flange of one received in the groove of the other.

11. The toilet bolt cap of claim 10, wherein the base further comprises a plurality of grabbers in the inside space that are attached to the inside surface or formed integral with the side wall, and wherein each grabber extends toward the upper end and toward the longitudinal axis of the base.

12. A cap for covering a bolt comprising: a base and a cover that attaches to the base, wherein the base has a side wall, a lower end of the side wall and an upper end of the side wall, wherein
the side wall of the base has an outside surface, wherein
the outside surface of the side wall of the base has a circumferential flange or groove, wherein
the base has a plurality of grabbers that are attached to or formed integral with the lower end of the base, wherein
each grabber extends away from the lower end of the base and slopes inwardly toward a longitudinal axis of the base, wherein
the grabbers are sized and designed to press against the toilet bolt, wherein
the cover has a side wall, a lower end that is open and an upper end that is closed, wherein
the side wall of the cover has an inside surface, and wherein
the inside surface of the side wall of the cover has a circumferential groove or flange for matingly engaging the circumferential flange or groove on or in the outside surface of the side wall of the base in a snap fit and/or in an interference fit.

13. The cap of claim 12, wherein the base has a plurality of holders, wherein each holder extends away from the lower end of the base and slopes inwardly toward a longitudinal axis of the base and then transition through a bend and then extends away from the lower end of the base and becomes a riser, wherein the risers are designed and sized to press against the bolt.

14. The cap of claim 13, wherein the cover has a plurality of stiffening ribs attached to or formed integral with an inside surface of the upper end and the side wall of the cover.

15. The cap of claim 13, wherein the side wall of the base has an inside surface, wherein the grabbers and the holders of the base have a lower surface, and wherein the inside surface of the side wall of the base and the lower surfaces of the grabbers and holders define a space for covering a nut on a bolt.

16. The cap of claim 13, wherein a cross-section of each riser has an arcuate shape for matingly engaging a bolt.

17. The cap of claim 12, wherein the base and the cover have a corresponding cylindrical or cuboidal shape.

18. A toilet bolt cap for covering a toilet bolt and a nut, where the toilet bolt extends some distance away from the toilet and beyond the nut, the toilet bolt cap comprising:
a cup-shaped cap having an open end, an opposing closed end and a sidewall between the open and closed ends, wherein the sidewall and the closed end define an interior cavity;
a first pair of opposing posts received in the cavity and attached to or formed integral with the closed end, wherein the first pair of opposing posts are spaced apart a first distance;
a second pair of opposing posts received in the cavity and attached to or formed integral with the closed end, wherein the second pair of opposing posts are spaced apart a second distance, and wherein the second distance is different from the first distance, wherein
the first and second pairs of opposing posts extend from the closed end toward the open end, and wherein the first and second pairs of opposing posts are arranged so as to partially define a bore hole for receiving the toilet bolt.

19. A kit for covering a toilet bolt and a nut, wherein the toilet bolt extends some distance beyond the nut, the kit comprising: a cap having a bore hole;
a first removable insert designed and sized for receipt in the bore hole of the cap, wherein the first removable insert has a tubular shape with a longitudinal opening defined by female threads sized and designed to receive a first toilet bolt in a threaded engagement, wherein the first removable insert can be threaded onto the first toilet bolt after which the first removable insert and the first toilet bolt can be received in the bore hole of the cap so that the cap will cover and hide the first toilet bolt and the first removable insert; and
a second removable insert designed and sized for receipt in the bore hole of the cap, wherein the second removable insert has a tubular shape with a longitudinal opening defined by female threads sized and designed to receive a second toilet bolt in a threaded engagement, wherein the second toilet bolt has a different diameter than the first toilet bolt, and wherein the first and second removable inserts are interchangeable with respect to the cap.
